(19) United States
(12) Patent Application Publication
(10) Pub. No.: US 2026/0024254 A1
(43) Pub. Date: Jan. 22, 2026

(54) METHOD, APPARATUS, DEVICE AND STORAGE MEDIUM OF IMAGE EDITING

(71) Applicant: Beijing Zitiao Network Technology Co., Ltd., Beijing (CN)

(72) Inventors: Yiming Fan, Beijing (CN); Yixing Huang, Beijing (CN); Yu Zhang, Beijing (CN); Wenpeng Xiao, Beijing (CN)

(21) Appl. No.: 19/270,870

(22) Filed: Jul. 16, 2025

(30) Foreign Application Priority Data
Jul. 17, 2024 (CN) 202410962621.1

(51) Int. Cl. G06T 11/60; G06T 5/50

(52) U.S. Cl. CPC G06T 11/60; G06T 5/50; G06T 2200/24; G06T 2207/20221

(57) ABSTRACT

Embodiment of the disclosure provides a method, an apparatus, a device, a storage medium of image editing. The method comprises: displaying an image editing interface comprising a canvas component associated with a plurality of layers; receiving an interaction operation for the plurality of layers, wherein the interaction operation indicates a selection of a set of layers in the plurality of layers; obtaining a target image generated by fusing the set of layers; and creating a target layer corresponding to the target image in the image editing interface to display the target image in the canvas component. In this way, embodiments of the disclosure can improve the efficiency of image editing.

### CROSS-REFERENCE

This application claims the benefit of Chinese Patent Application No. 202410962621.1 entitled “METHOD, APPARATUS, DEVICE AND STORAGE MEDIUM OF IMAGE EDITING” filed on Jul. 17, 2024, the entire content of which is incorporated herein by reference.

### FIELD

Example embodiments of the present disclosure generally relate to the field of computers, and in particular, to a method, an apparatus, a device, and a computer-readable storage medium of image editing.

### BACKGROUND

With the development of computer technologies, image editing tools have become common tools for people. Such an image editing tool may, for example, support the user to edit the size of the image, adjust the color of the image, etc.

### SUMMARY

In a first aspect of the present disclosure, a method of image editing is provided. The method comprises: displaying an image editing interface comprising a canvas component associated with a plurality of layers; receiving an interaction operation for the plurality of layers, wherein the interaction operation indicates a selection of a set of layers in the plurality of layers; obtaining a target image generated by fusing the set of layers; and creating a target layer corresponding to the target image in the image editing interface to display the target image in the canvas component.

In a second aspect of the present disclosure, an apparatus for image editing is provided. The apparatus comprises: a display module configured to display an image editing interface, wherein the image editing interface comprises a canvas component associated with a plurality of layers; a receiving module configured to receive an interaction operation for the plurality of layers, wherein the interaction operation indicates selection of a set of layers in the plurality of layers; an obtaining module configured to display a target image generated by fusing the set of layers; and a creating module configured to create a target layer corresponding to the target image in the image editing interface to display the target image in the canvas component.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2A to FIG. 2D are schematic diagrams illustrating an interface according to some embodiments of the present disclosure;

FIG. 3 shows a flowchart of a process of image editing according to some embodiments of the present disclosure;

FIG. 4 shows a schematic structural block diagram of an image editing apparatus according to some embodiments of the present disclosure;

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, embodiments described in any section/subsection may be combined in any manner with the same section/subsection and/or any other embodiment described in different sections/subsections.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In embodiments of the present disclosure, all data is collected, obtained, processed, processed, forwarded, used, etc., all of which are performed on the premise that the user knows and confirms. Accordingly, when implementing embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

This specification and embodiments described herein, when involving the processing of personal information, will be carried out only on the basis of a lawful foundation (such as obtaining consent from the data subject or as necessary for the performance of a contract, etc.), and will only be processed within the scope defined or agreed upon. Users' refusal to process personal information other than the necessary information required for basic functions will not affect their use of the basic functions.

As discussed above, an image editing tool can improve the ability of people to improve various image editing. In some image editing scenarios, it is desirable to combine different images. For example, one may add some visual elements to a background image, thereby achieving overlay display. However, images obtained in this manner lack realism.

Embodiments of the invention provides a scheme of image editing. The scheme comprises the following steps: displaying an image editing interface, wherein the image editing interface comprises a canvas component associated with the plurality of layers; receiving an interaction operation for the plurality of layers, wherein the interaction operation indicates selection of a set of layers in the plurality of layers; obtaining a target image generated by fusing the set of layers; and creating a target layer corresponding to the target image in the image editing interface to display the target image in the canvas component.

In this way, embodiments of the present disclosure may support a more flexible layer fusion process, and may create a newly generated image as a new layer, thereby improving efficiency of image editing.

### Example Environment

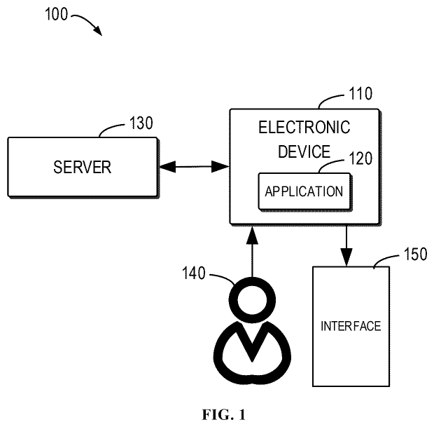

FIG. 1 illustrates a schematic diagram of an example environment 100 in which embodiments of the present disclosure can be implemented. As shown in FIG. 1, the example environment 100 may include an electronic device 110.

In this example environment 100, an application 120 is installed in the electronic device 110. A user 140 may interact with the application 120 via the electronic device 110 and/or its attachment device. The application 120 may be a media editing application, or any other suitable application. For example, the application 120 may be a browser and provide a media editing service by accessing a website.

In the environment 100 of FIG. 1, if the application 120 is in an active state, the application 120 may provide a presentation interface 150 for the user 140. The user 140 may perform a media editing operation based on the interface 150.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support content presentation in the electronic device 110.

A communication connection may be established between the server 130 and the electronic device 110. The communication connection may be established in a wired manner or a wireless manner. Communication connections may include, but are not limited to, Bluetooth connections, mobile network connections, universal serial bus connections, wireless fidelity connections, etc., embodiments of the present disclosure are not limited in this respect. In embodiments of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

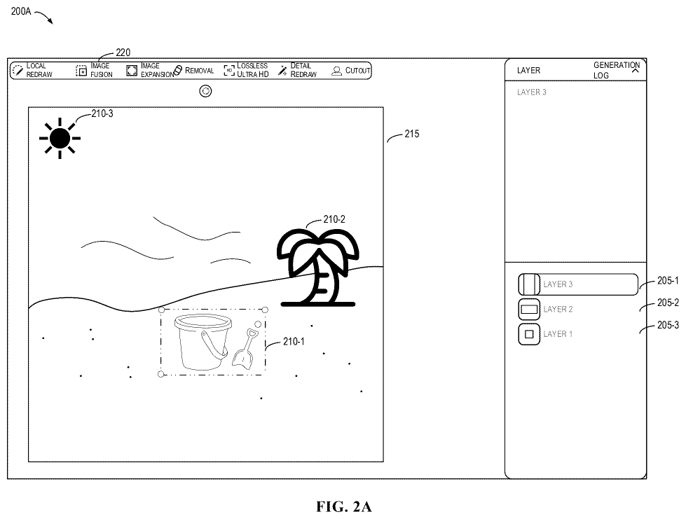

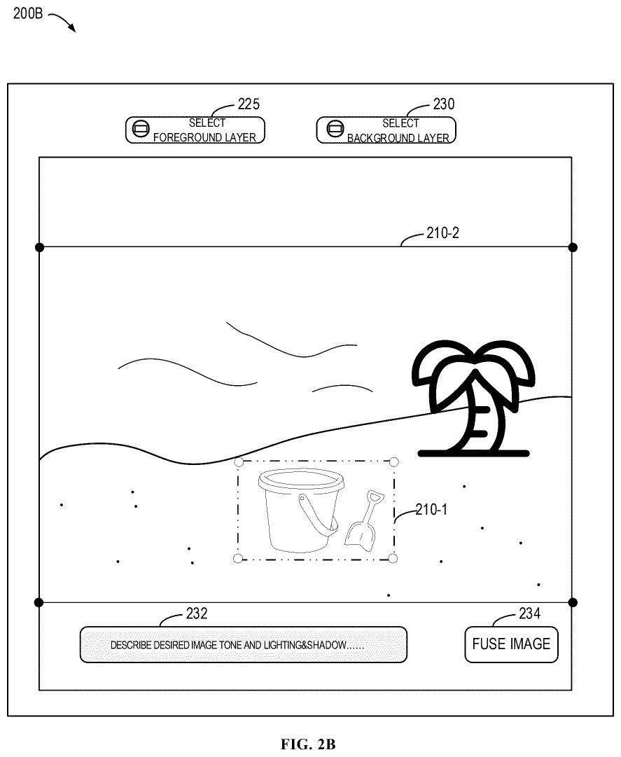

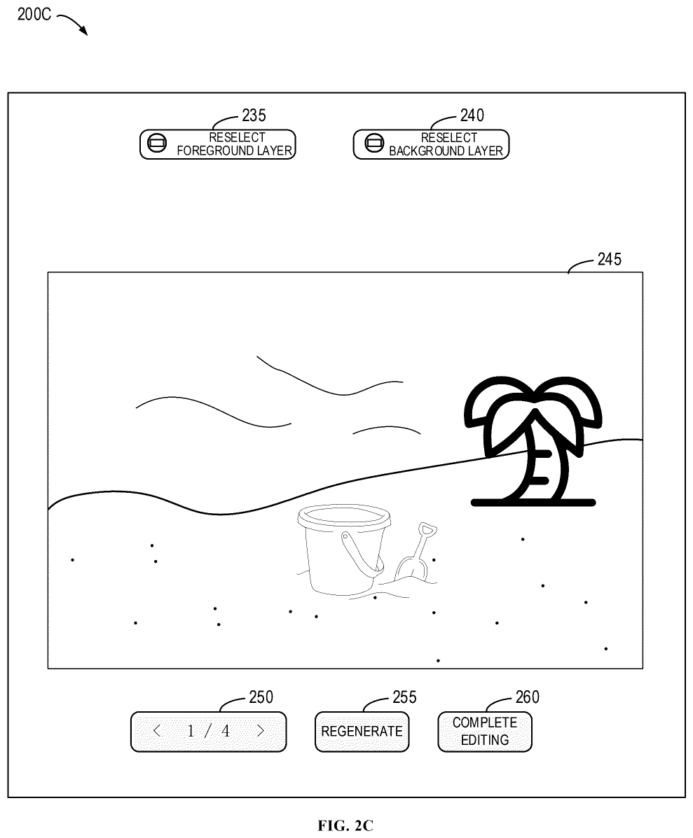

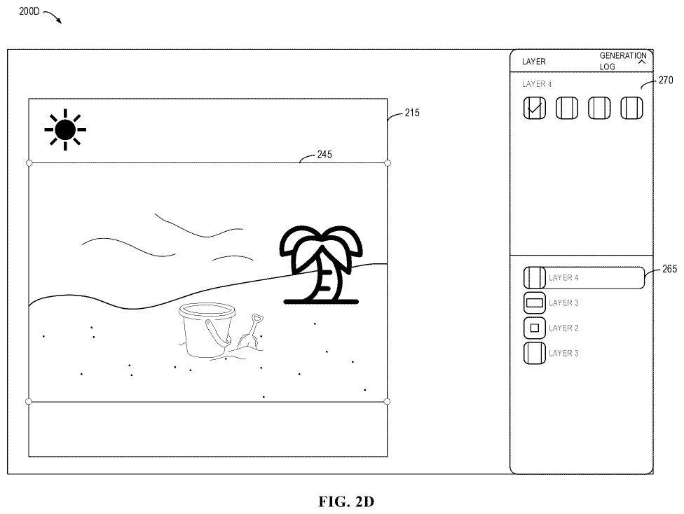

An example interaction process according to embodiments of the present disclosure will be described below with reference to FIGS. 2A-2D. FIGS. 2A-2D illustrate example interfaces 200A-200D, which may be provided by the electronic device 110 shown in FIG. 1, for example, in accordance with some embodiments of the present disclosure.

FIG. 2A illustrates an image editing interface 200A in accordance with some embodiments of the present disclosure. As shown in FIG. 2A, the interface 200A includes a canvas component 215, for example, may be associated with one or more layers, for example, a layer 205-1, a layer 205-2, and a layer 205-3 (individually or collectively referred to as a layer 205).

In some embodiments, the electronic device 110 may add, delete, or edit the layer 205 based on the layer editing operation. Correspondingly, the canvas component 215 may display the visual content corresponding to each layer by overlaying the layers on the basis of the order of the layers. For example, the canvas component 215 may display an image 210-1 corresponding to the layer 205-1, an image 210-2 corresponding to the layer 205-2, and an image 210-3 corresponding to the layer 205-3. The images 210-1 to 210-3 may also be referred to individually or collectively as images 210.

In some embodiments, the layer 205 may also correspond to other types of visual content, for example, stickers, texts, and the like. The layer of this type may also support the layer fusion operation of the present disclosure, and the visual content corresponding to the layer may be, for example, converted into an image to perform layer fusion. The following describes an example process of layer fusion by using a layer corresponding to the image content as an example.

As an example, the electronic device 110 may edit the image 210 corresponding to each layer 205 in the canvas component 215 based on the received editing operation, for example, moving or scaling image 210, and the like.

In some embodiments, the electronic device 110 may receive a user selection of the layer 205-1 or the image 210-1 corresponding to the layer 205-1. For example, the electronic device 110 may receive a user's selection of the layer 205-1 in the layer list. Alternatively, the user may also select the image 210-1 corresponding to the layer 205-1 through the canvas component 215.

Accordingly, the electronic device 110 may present a set of editing controls associated with the layer 205-1. As shown in FIG. 2A, the set of editing controls may include a fusion control 220.

In some embodiments, after receiving the trigger for the fusion control 220, the electronic device 110 may display the interface 200B shown in FIG. 2B. As shown in FIG. 2B, the electronic device 110 may provide a foreground layer selection control 225 (also referred to as a first layer selection control) and a background layer selection control 230 (also referred to as a second layer selection control).

As an example, the foreground layer selection control 225 may be configured to select one or more layers, and determine the one or more layers as a foreground layer to be fused. The background layer selection control 230 may be configured to select one or more layers, and determine the one or more layers as a background layer to be fused.

In some embodiments, the electronic device 110 may further automatically add the layer 205-1 to the foreground layer or the background layer based on the layer sequence of the layer 205-1 selected by the user in the plurality of layers. Taking FIG. 2B as an example, the layer 205-1 may correspond to a top layer in the plurality of layers 205, and the layer 205-1 may be added as a foreground layer.

In some scenarios, the user may select the layer 205-2 and trigger the layer fusion operation, for example. Correspondingly, since the layer 205-2 is a bottom layer in the plurality of layers 205, the layer 205-2 may be added as a background layer.

In some embodiments, the foreground layer selection control 225 or the background layer selection control 230 may also display a preview image of the selected foreground layer or background layer, for example.

In some embodiments, when the layer 205-1 is determined as the foreground layer, the electronic device 110 may further display, in the canvas component 215, the first marking element corresponding to the outline of the image 210-1 to indicate that the corresponding layer 205-1 is selected as the foreground layer.

Additionally, the electronic device 110 may receive a selection of the background layer selection control 230 and may enter a background layer selection mode. For example, the user may select the layer 205-2 as the background layer to be fused by clicking the layer 205-2 in the layer list or clicking the image 210-2 corresponding to the layer 205-2 in the canvas component 215.

Similarly, the electronic device 110 may display, in the canvas component 215, a second marking element corresponding to the outline of the image 210-2 to indicate that the corresponding layer 205-2 is selected as the background layer. As an example, the first marking element and the second marking element may have different patterns, for example, different contour colors, contour lines of different patterns, and the like.

In some embodiments, the electronic device 110 may further provide a prompt input control 232 to obtain a prompt input by the user. In some embodiments, such a prompt may be used to describe hue information or lighting and shadow information of the fused image to be generated.

In some embodiments, the electronic device 110 may further support a user in configuring control parameters for the fusion process, for example. As an example, the control parameters may be used, for example, to indicate a degree to which an image in the foreground layer is reserved.

Further, the electronic device 110 may receive a user selection of the fused button 234 to trigger performing the fusion process based on the selected set of layers (for example, the layer 205-1 and the layer 205-2).

In some embodiments, the fusion process may be performed by the electronic device 110 and/or the server 130. Specific details regarding the fusion process will be described in detail below. Further, the electronic device 110 may obtain one or more images generated by fusing the set of layers.

In some embodiments, the electronic device 110 may obtain a plurality of images generated by fusing the set of layers. For example, in the example shown in FIG. 2C, a single fusion request may trigger generation of four images. The electronic device 110 may, for example, display the target image 245 in the image viewing window 200C as shown in FIG. 2C.

Further, the electronic device 110 may, for example, switch to displaying other images in the generated plurality of images based on the received first preset operation (for example, selection of the control 250). Additionally, the electronic device 110 may further generate a new set of images based on the set of layers based on the received second preset operation (for example, selection of the control 255).

For example, upon receiving the selection of control 255, electronic device 110 may obtain additional four images reuploaded by fusing the set of layers, and may provide eight images for viewing and/or selection by the user.

Additionally, the electronic device 110 may also provide a control 235 for reselecting the foreground layer and a control 240 for reselecting the background layer in the window 200C, for example. After receiving the selection of the control 235 or the control 240, the electronic device 110 may, for example, re-select the layer selection interface as shown in FIG. 2B.

In some embodiments, the electronic device 110 may, for example, receive a trigger for the control 260 by the user to indicate a selection of the target image 245 displayed in the window 200C.

Further, as shown in FIG. 2D, the electronic device 110 may create a layer 265 corresponding to the selected target image 245 in the image editing interface. Further, the electronic device 110 may display the selected target image 245 in the canvas component 215.

In some embodiments, the created layer 265 may have the highest layer priority, for example, to be superimposed and displayed on the existing layer 205.

Further, the electronic device 110 may support the user further editing the created layer 265 in the image editing interface. The present disclosure is not intended to limit the specific subsequent editing process of the layer 265.

In some embodiments, as shown in FIG. 2D, the electronic device 110 may further display an image selection area 270 corresponding to the layer 265 in the interface 200D. The image selection area 270 may display images generated by the fusion layer 205-1 and the layer 205-2. For example, the image selection area 270 may display four images corresponding to the image viewing window 200C.

Further, the electronic device 110 may support the user selecting another image in the image selection area 270 to associate the layer 265 to the selected another image. Accordingly, the electronic device 110 may update the canvas component 215 to display the selected another image.

Based on the foregoing process, embodiments of the present disclosure may support a more flexible layer fusion process, and may create a newly generated image as a new layer, thereby improving image editing efficiency.

The specific generation process of the target image 245 will be further described below. In some embodiments, the electronic device 110 and/or the server 130 may utilize a target model to perform a fusion process to generate the target image 245. As an example, such a target model may include an image generation model.

Specifically, the electronic device 110 and/or the server 130 may extract the foreground object in the foreground layer in the set of layers. Taking layer 205-1 as an example of a foreground layer, the electronic device 110 and/or the server 130 may extract a foreground object, for example, a bucket and a shovel, from the layer 205-1 by using an appropriate entity extraction technology.

Further, the electronic device 110 and/or the server 130 may add the foreground object to the background layer in the set of layers to generate the intermediate image. For example, the electronic device 110 and/or the server 130 may directly superimpose the extracted bucket and the shovel onto the corresponding position of the background layer 205-2 to obtain the intermediate image.

Additionally, the electronic device 110 and/or the server 130 may construct the input information of the target model based on the intermediate image and the mask information corresponding to the foreground object. As an example, the mask information may indicate, for example, an area of the foreground object in the background layer.

Specifically, the electronic device 110 and/or the server 130 may use the intermediate image as an initial input of the image generation model, and may control, by using the mask information, the mixture of the feature representation corresponding to the intermediate image and the feature representation corresponding to the foreground object.

In some embodiments, the input information of the image generation model may further include a control parameter corresponding to the foreground object. As an example, the control parameter indicates a degree of change of the foreground object. In some embodiments, as described above, the control parameter may be input by a user configuring an image editing interface. Alternatively, the control parameter may be, for example, a preset parameter.

Additionally, the input information of the image generation model may further include a prompt input by the user. As introduced above, the prompt may describe the color information and/or the lighting and shadow information of the fused image to be generated.

Further, the image generation model may perform an image fusion process based on the received input information, to complete fusion between different layers.

### Example Processes

FIG. 3 shows a flowchart of a process 300 of image editing according to some embodiments of the present disclosure. Process 300 may be implemented at electronic device 110. The process 300 is described below with reference to FIG. 1.

At block 310, the electronic device 110 displays a display image editing interface that includes a canvas component associated with a plurality of layers.

At block 320, the electronic device 110 receives an interaction operation for a plurality of layers, the interaction operation indicating selection of a set of layers of the plurality of layers.

At block 330, the electronic device 110 obtains a target image generated by fusing a set of layers.

At block 340, the electronic device 110 creates a target layer corresponding to the target image in the image editing interface to display the target image in the canvas component.

In some embodiments, receiving the interaction operation for the plurality of layers includes: receiving a fusion request for a first layer in the plurality of layers; in response to the fusion request, displaying a first layer selection control for selecting the foreground layer and/or a second layer selection control for selecting the background layer; and determining a set of layers to be fused via the first layer selection control and/or the second layer selection control.

In some embodiments, receiving the fusion request for the first layer in the plurality of layers includes: receiving a selection of the first layer or an image corresponding to the first layer; displaying a fusion control associated with the first layer; and in response to selection of the fusion control, receiving the fusion request.

In some embodiments, the method 300 further includes: based on a layer sequence of the first layer in the plurality of layers, adding the first layer as a foreground layer or a background layer.

In some embodiments, the determining the set of layers to be fused via the first layer selection control and/or the second layer selection control includes: selecting a second layer of the plurality of layers via the first layer selection control and/or the second layer selection control; and determining a set of layers to be fused based on the first layer and the second layer.

In some embodiments, the obtaining a target image generated by fusing a set of layers includes: obtaining an input target prompt through a prompt input control; and obtaining a target image generated by fusing a set of layers based on the target prompt by the target model.

In some embodiments, the prompt describes color information and/or lighting and shadow information of the fused image to be generated.

In some embodiments, obtaining a target image generated by fusing a set of layers includes: obtaining a first set of images generated by fusing a set of layers; and displaying a target image in the first set of images in an image viewing window.

In some embodiments, the method 300 further includes: in response to receiving the first preset operation, displaying another image in the first set of images in the image viewing window; and/or in response to receiving the second preset operation, triggering generation of a second set of images by fusing the set of layers.

In some embodiments, the method 300 further includes: displaying an image selection area corresponding to the target layer in the image editing interface, the image selection area displaying the first set of images generated by fusing the set of layers.

In some embodiments, the target image is generated through the following process: extracting a foreground object in a foreground layer in the set of layers; adding the foreground object to the background layer in the set of layers to generate an intermediate image; and constructing input information of the target model based on the intermediate image and the mask information corresponding to the foreground object, so as to control the target model to generate the target image.

In some embodiments, the input information further indicates a control parameter corresponding to the foreground object, and the control parameter indicates a degree of change of the foreground object; and/or a prompt that describes color information and/or lighting and shadow information of the fused image to be generated.

### Example Apparatus and Device

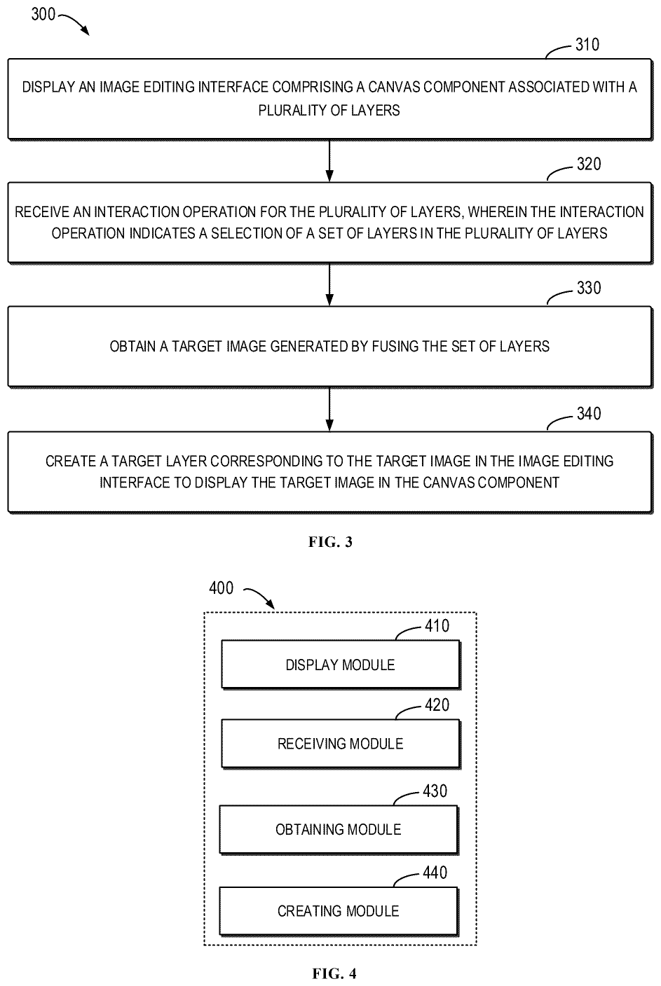

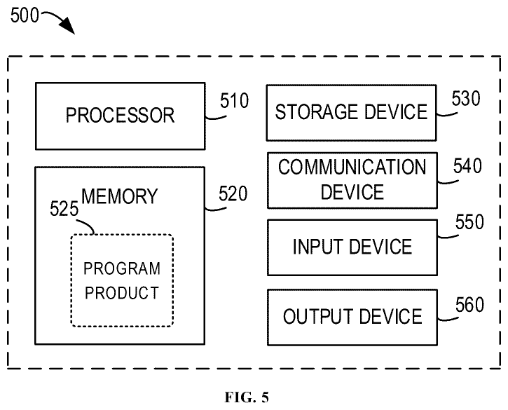

Embodiments of the present disclosure also provide a corresponding apparatus for implementing the above method or process. FIG. 4 shows a schematic structural block diagram of an apparatus 400 for image editing according to some embodiments of the present disclosure. The apparatus 400 may be implemented or included in the electronic device 110 as discussed above. The various modules/components in the apparatus 400 may be implemented by hardware, software, firmware, or any combination thereof.

As shown in FIG. 4, the apparatus 400 includes a display module 410 configured to display an image editing interface, where the image editing interface includes a canvas component, and the canvas component is associated with a plurality of layers; a receiving module 420, configured to receive an interaction operation for the plurality of layers, where the interaction operation indicates a selection of a set of layers in the plurality of layers; an obtaining module 430, configured to display a target image generated by fusing the set of layers; and a creating module 440, configured to create, in the image editing interface, a target layer corresponding to the target image, so as to display the target image in the canvas component.

In some embodiments, the receiving module 420 is further configured to: receive a fusion request for a first layer in the plurality of layers; in response to the fusion request, display a first layer selection control for selecting the foreground layer and/or a second layer selection control for selecting the background layer; and determine a set of layers to be fused via the first layer selection control and/or the second layer control.

In some embodiments, the receiving module 420 is further configured to: receive a selection of a first layer or an image corresponding to the first layer; display a fusion control associated with the first layer; and receive a fusion request in response to a selection of the fusion control.

In some embodiments, the apparatus 400 further includes an adding module configured to add the first layer as a foreground layer or a background layer based on a layer sequence of the first layer in the plurality of layers.

In some embodiments, the receiving module 420 is further configured to: select a second layer of the plurality of layers via the first layer selection control and/or the second layer selection control; and determine a set of layers to be fused based on the first layer and the second layer.

In some embodiments, the obtaining module 430 is further configured to: obtain an input target prompt via a prompt input control; and obtain a target image, where the target image is generated by fusing the set of layers based on the target prompt by the target model.

In some embodiments, the prompt describes color information and/or lighting and shadow information of the fused image to be generated.

In some embodiments, the obtaining module 430 is further configured to: obtain a first set of images generated by fusing the set of layers; and display the target image in the first set of images in the image viewing window.

In some embodiments, the apparatus 400 further includes a first processing module configured to: in response to receiving a first preset operation, display another image in the first set of images in the image viewing window; and/or in response to receiving a second preset operation, trigger generation of a second set of images by fusing the set of layers.

In some embodiments, the apparatus 400 further includes a second processing module configured to: display, in the image editing interface, an image selection area corresponding to the target layer, wherein the image selection area displays the first set of images generated by fusing the set of layers.

In some embodiments, the target image is generated based on the following process: extracting the foreground object in the foreground layer in the set of layers; adding the foreground object to the background layer in the set of layers to generate an intermediate image; and constructing the input information of the target model based on the intermediate image and the mask information corresponding to the foreground object, so as to control the target model to generate the target image.

In some embodiments, the input information further indicates a control parameter corresponding to the foreground object, and the control parameter indicates a degree of change of the foreground object; and/or a prompt that describes color information and/or lighting and shadow information of the fused image to be generated.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of embodiments described herein. The electronic device 500 shown in FIG. 5 may be configured to implement the electronic device 110 shown in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data (e.g., training data for training) and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of image editing, comprising:
displaying an image editing interface comprising a canvas component associated with a plurality of layers;
receiving an interaction operation for the plurality of layers, wherein the interaction operation indicates a selection of a set of layers in the plurality of layers;
obtaining a target image generated by fusing the set of layers; and
creating a target layer corresponding to the target image in the image editing interface to display the target image in the canvas component.

2. The method of claim 1, wherein receiving an interaction operation for the plurality of layers comprises:
receiving a fusion request for a first layer in the plurality of layers;
in response to the fusion request, displaying a first layer selection control for selecting a foreground layer and/or a second layer selection control for selecting a background layer; and
determining the set of layers to be fused via the first layer selection control and/or the second layer selection control.

3. The method of claim 2, wherein receiving the fusion request for the first layer in the plurality of layers comprises:
receiving a selection of the first layer or a visual content corresponding to the first layer;
displaying a fusion control associated with the first layer; and
receiving the fusion request in response to a selection of the fusion control.

4. The method of claim 2, further comprising:
adding the first layer as the foreground layer or the background layer based on a layer sequence of the first layer in the plurality of layers.

5. The method of claim 2, wherein determining the set of layers to be fused via the first layer selection control and/or the second layer selection control comprises:
selecting a second layer of the plurality of layers via the first layer selection control and/or the second layer selection control; and
determining the set of layers to be fused based on the first layer and the second layer.

6. The method of claim 1, wherein obtaining the target image generated by fusing the set of layers comprises:
obtaining an input target prompt through a prompt input control; and
obtaining the target image, where the target image is generated by fusing the set of layers based on the target prompt by a target model.

7. The method of claim 6, wherein the prompt describes color information and/or lighting and shadow information of a fused image to be generated.

8. The method of claim 1, wherein obtaining the target image generated by fusing the set of layers comprises:
obtaining a first set of images generated by fusing the set of layers; and
displaying the target image in the first set of images in an image viewing window.

9. The method of claim 8, further comprising:
in response to receiving a first preset operation, displaying another image in the first set of images in the image viewing window; and/or
in response to receiving a second preset operation, triggering generation of a second set of images by fusing the set of layers.

10. The method of claim 8, further comprising:
displaying an image selection area corresponding to the target layer in the image editing interface, wherein the image selection area displays the first set of images generated by fusing the set of layers.

11. The method of claim 1, wherein the target image is generated through:
extracting a foreground object in a foreground layer in the set of layers;
adding the foreground object to a background layer in the set of layers to generate an intermediate image; and
constructing, based on the intermediate image and mask information corresponding to the foreground object, input information of the target model to control the target model to generate the target image.

12. The method of claim 11, wherein the input information further indicate:
a control parameter corresponding to the foreground object, wherein the control parameter indicates a degree of change of the foreground object; and/or
a prompt describing color information and/or lighting and shadow information of a fused image to be generated.

13. An electronic device, comprising:
at least one processing unit; and
at least one memory coupled to the at least one processing unit and storing instructions for execution by the at least one processing unit, the instructions, when executed by the at least one processing unit, causing the electronic device to perform:
displaying an image editing interface comprising a canvas component associated with a plurality of layers;
receiving an interaction operation for the plurality of layers, wherein the interaction operation indicates a selection of a set of layers in the plurality of layers;
obtaining a target image generated by fusing the set of layers; and
creating a target layer corresponding to the target image in the image editing interface to display the target image in the canvas component.

14. The electronic device of claim 13, wherein receiving an interaction operation for the plurality of layers comprises:
receiving a fusion request for a first layer in the plurality of layers;
in response to the fusion request, displaying a first layer selection control for selecting a foreground layer and/or a second layer selection control for selecting a background layer; and
determining the set of layers to be fused via the first layer selection control and/or the second layer selection control.

15. The electronic device of claim 14, wherein receiving the fusion request for the first layer in the plurality of layers comprises:
receiving a selection of the first layer or a visual content corresponding to the first layer;
displaying a fusion control associated with the first layer; and
receiving the fusion request in response to a selection of the fusion control.

16. The electronic device of claim 14, wherein the instructions, when executed by the at least one processing unit, further causes the electronic device to perform:
adding the first layer as the foreground layer or the background layer based on a layer sequence of the first layer in the plurality of layers.

17. The electronic device of claim 14, wherein determining the set of layers to be fused via the first layer selection control and/or the second layer selection control comprises:
selecting a second layer of the plurality of layers via the first layer selection control and/or the second layer selection control; and
determining the set of layers to be fused based on the first layer and the second layer.

18. The electronic device of claim 13, wherein obtaining the target image generated by fusing the set of layers comprises:
obtaining an input target prompt through a prompt input control; and
obtaining the target image, where the target image is generated by fusing the set of layers based on the target prompt by a target model.

19. The electronic device of claim 18, wherein the prompt describes color information and/or lighting and shadow information of a fused image to be generated.

20. A non-transitory computer-readable storage medium having stored thereon a computer program which, when executed by a processor, implements:
displaying an image editing interface comprising a canvas component associated with a plurality of layers;
receiving an interaction operation for the plurality of layers, wherein the interaction operation indicates a selection of a set of layers in the plurality of layers;
obtaining a target image generated by fusing the set of layers; and
creating a target layer corresponding to the target image in the image editing interface to display the target image in the canvas component.
